(19) United States
(12) Patent Application Publication
(10) Pub. No.: US 2011/0247064 A1
(43) Pub. Date: Oct. 6, 2011

(54) METHOD AND APPARATUS FOR PROTECTING INFORMATION IN USER TERMINAL

(75) Inventor: Jin-Wook KIM, Seoul (KR)

(73) Assignee: SAMSUNG ELECTRONICS CO., LTD., Gyeonggi-Do (KR)

(21) Appl. No.: 13/075,274

(22) Filed: Mar. 30, 2011

(30) Foreign Application Priority Data
Apr. 2, 2010 (KR) 10-2010-0030393

(51) Int. Cl. H04L 9/32; G06F 21/00

(52) U.S. Cl. 726/7

(57) ABSTRACT

A terminal includes: an input unit receiving setting data including time data and position data; a storage unit storing the received setting data; a position information generating unit generating position information of the terminal; a determination unit comparing the position data with the generated position information to determine whether to limit functions of the terminal or not, at a time corresponding to the time data; and a controller controlling to limit at least one function of the terminal according to the determination outcome.

### CLAIM OF PRIORITY

This application claims priority under 35 U.S.C. §119 to an application filed in the Korean Intellectual Property Office on Apr. 2, 2010 and assigned Serial No. 10-2010-0030393, the contents of which are incorporated herein by reference.

### BACKGROUND OF THE INVENTION

1. Field of the Invention

The present invention relates generally to a method for protecting information of a terminal, and in particular, to a method for protecting information more effectively according to predetermined criteria.

2. Description of the Related Art

Personal and private information of a user or business data are stored in a terminal. If the terminal is stolen or lost, the information stored in the terminal may be easily accessed by others. As one example, if someone picking up the terminal decodes password set in the terminal through input of an arbitrary password, the information stored in the terminal can be exposed to unintended others.

### SUMMARY OF THE INVENTION

An aspect of the present invention is to substantially solve at least the above problems and/or disadvantages and to provide at least the advantages below. Accordingly, an aspect of the present invention is to provide a method and an apparatus for preventing information stored in a terminal from being accessed by others.

In accordance with an exemplary aspect of the present invention, a terminal apparatus for protecting information includes: an input unit receiving setting data including time data and position data; a storage unit storing the received setting data; a position information generating unit generating a position information of a terminal; a determination unit comparing the position data with the generated position information to determine whether to limit the functions of the terminal at a time designated in the time data; and a controller controlling to limit at least one function of the terminal according to the determination result.

In accordance with another exemplary aspect of the present invention, a service system for protecting information includes: an authentication information managing unit storing and managing an authentication information used for a functional restoration of a terminal; a message generating unit generating a message including a control information that represents the functional restoration of the terminal; a transceiver receiving an input authentication information and transmitting the message to the terminal; and an authentication information determining unit determining whether an authentication is successful by comparing the stored authentication information with the received input authentication information, wherein the message generating unit generates the message according to a determination result based on whether the authentication is successful in the authentication information determining unit.

In accordance with another exemplary aspect of the present invention, a terminal apparatus for restoring a limited function includes: a storage unit storing setting data including time data and position data; a position information generating unit generating a position information of a terminal; a controller controlling to limit at least one function of the terminal when the generated position information is not included in the position data at a time specified in the time data; and a transceiver receiving a functional restoration message including a control information from a service system, wherein the controller controls to restore the at least one function of the terminal according to the control information.

In accordance with another exemplary aspect of the present invention, a method for restoring a limited function in a terminal apparatus includes: maintaining a storage unit storing setting data including time data and position data; generating a position information of a terminal; controlling to limit at least one function of the terminal when the generated position information is not included in the position data at a time specified in the time data, with reference to the storage unit; receiving a functional restoration message including a control information from a service system; and controlling to restore the at least one function of the terminal according to the control information.

Other exemplary aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features and advantages of the present invention will become more apparent from the following detailed description when taken in conjunction with the accompanying drawings in which:

FIG. 1 is a block diagram illustrating a terminal device according to an embodiment of the present invention;

FIG. 2 is a block diagram illustrating a service system according to an embodiment of the present invention;

FIG. 3 is a flowchart illustrating operations of a terminal and a service system according to an embodiment of the present invention;

FIG. 4 is a flowchart illustrating an information protection procedure of a terminal according to an embodiment of the present invention; and

FIG. 5 is a flowchart illustrating operations of a service system for protecting information of a terminal according to an embodiment of the present invention.

### DETAILED DESCRIPTION

The following description, with reference to the accompanying drawings, is provided to assist a person of ordinary skill in the art with a comprehensive understanding of certain exemplary embodiments of the invention provided herein for illustrative purposes. The description includes various specific details to assist a person of ordinary skill the art with understanding the claimed invention, but these details are to be regarded as merely exemplary. Accordingly, those of ordinary skill in the art will recognize that various changes and modifications of the illustrative examples described herein can be made without departing from the spirit of the invention and the scope of the appended claims. Further, for the purposes of clarity and simplicity, descriptions of well-known functions and constructions may be omitted as their inclusion may obscure appreciation of the subject matter of the claimed invention by a person of ordinary skill in the art.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustrative purposes only and is not to be construed as limiting the invention as defined by the appended claims and their equivalents.

It is to be understood that the singular forms “a,” “an,” and “the” include plural references unless the context clearly dictates otherwise. Thus, for example, a reference to “a component surface” includes reference to one or more of such surfaces.

By the term “substantially” it is typically meant that the recited characteristic, parameter, or value need not be achieved exactly, but that deviations or variations, including but in no way limited to, for example, tolerances, measurement error, measurement accuracy limitations and other factors known to persons of ordinary skill in the art, may occur in amounts that do not preclude the effect the characteristic was intended to provide.

Hereinafter, according to embodiments of the present invention, an information protecting apparatus and method will be described using a terminal. Note that the teachings of present invention can be applied to other terminals, such as a computer, a communication device, a wireless communication device, a portable electronic device, a mobile electronic device, and a mobile phone,

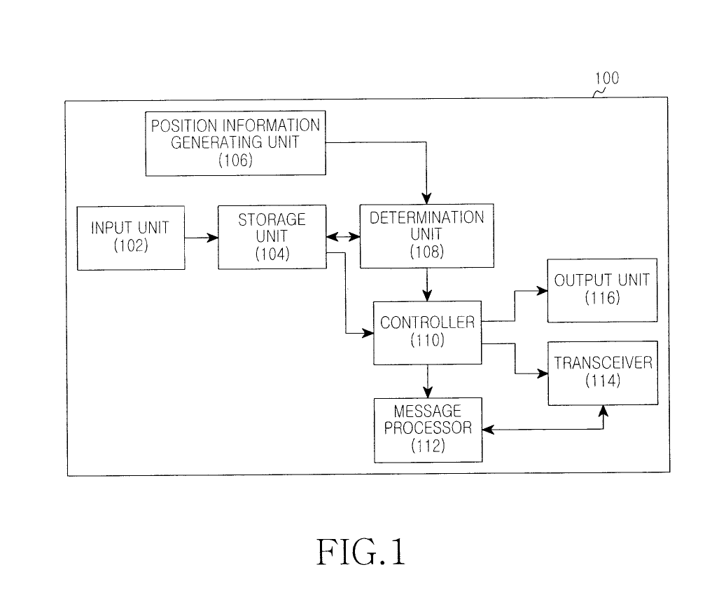

FIG. 1 is a block diagram illustrating a terminal device according to an embodiment of the present invention.

Referring now to FIG. 1, the terminal 100 may include an input unit 102, a storage unit 104, a position information generator 106, a determination unit 108, a controller 110, a message processor 112, a transceiver 114, and an output unit 116.

The input unit 102 receives setting data which may include time data and position data. The setting data may be inputted directly by a user through the terminal 100 or setting data that a user presets or enters may be transmitted from a service system. The time data may include information related to a specified time for executing information protection of the terminal or time period including starting time and ending time for executing a specific event. The timing data also may include a predetermined information relating to the execution of information protection.

The position data represents a predetermined position information of the terminal 100, used for determining when to execute the information protection of the terminal 100 by comparing it with indicating a current position of the terminal. The position data includes at least one of Global Positioning System (GPS) coordinates, latitude and longitude, a position on a map of the terminal 100 determined by a user, and a base station for providing service to the terminal 100. Determination of the position of the terminal can be performed according to the user's selection at any time. This is achieved by using the position data as a reference data to determine whether a current location of the terminal correspond to the location specified by the position data or the current location of the terminal is within the location specified by the position data by a predefined range or distance range. To this end, the input unit 102 may directly receive a setting position or a setting radius (or diameter) of the terminal 100 from a user. For example, the position data may include circular area information having a setting radius (or diameter) where the position of the terminal 100 is the center point. Or, the position data may include a default or arbitrary area information surrounding the position of the terminal 100. Note that current location of the terminal can be determined using a conventional GPS scheme.

In alternate embodiment, position data of the terminal 100 may be diversely inputted. For example, the GPS coordinates may be inputted as position data. Alternatively, GPS coordinates of the terminal generated through the position information generator 106 may be used as the position data which will be used to be compared with a current position of the terminal. Further, with setting the GPS coordinates as the center point, circular area information having a radius size inputted from a user may be used as position data.

According to another embodiment of the present invention, after GPS coordinates and a mapping map are displayed to a user, and the user may further select/change a desired point or an area on the map. The selected point or area may be converted to the mapping GPS coordinates and then may be used as the position data which will be used to be compared with a current position of the terminal. Thus, the map displayed to a user may include a position corresponding to the GPS coordinates of the terminal 100 generated through the position information generator 106.

The setting data may further include a basic contact information such as a telephone number of a third wireless mobile phone. In operation, if a function of the terminal 100 is limited to protect information of the terminal 100, the terminal 100 may transmit a message including a current position information of the terminal 100 to the third wireless mobile phone using the basic contact information provided in the setting data.

Moreover, the setting data may include information related to types of functions that are allowed for the terminal 100 or type of functions to be limited thereof. That is, the setting data may further include information for executing at least one of (1) limiting function of the terminal 100 such as call and message receiving functions; (2) limiting an output about predetermined data; (3) limiting a call with a predetermined number or a predetermined communication function; or (4) requesting or adjusting functional limitations to a service system. For example, the terminal 100 may allow a user to select items from the above (1) through (4). However, if a more specific setting or adjustment in the setting is required for the selected items, the user may input additional settings through the input unit 102. In addition, when the terminal 100 receives picture information, a message, or contact information including phone numbers from the user, it can be programed so that the received information is set output-limited data. (i.e., designating a target or recipient for preventing an output including sound and display) through the input unit 102.

Furthermore, if the above (3) is set, the user may input whether to limit a communication function if a local code or a country code is included or a specific number for an overseas call is included. Here, the user may directly input information about whether to limit interact and data communication. Additionally, if the above (4) is set to be executed, the terminal 100 may transmit a message including an identifier of the terminal 100 to request functional limitations of the terminal 100 to a service system.

It should be noted that the above (1) through (4) are described for illustrative purposes, thus various modifications and settings can be set by the user or in advance in the terminal 100.

Referring back to FIG. 1, the storage unit 104 stores the setting data inputted by a user. The storage unit 104 may be realized using various forms of memories or hard disks. The storage unit 104 according to one aspect of the present invention may include a non-volatile memory.

The position information generator 106 generates a current information position of a terminal. The position information generator 106 may include a GPS receiving unit (not shown) and may generate a current position information of the terminal 100 using signals received from satellites. If the terminal 100 enters an area where no satellite signal is detected, the stored position information of the terminal 100 may be used. Additionally, the GPS receiving unit may operate only at a specified time (or a time zone) corresponding to the time provided in the setting data or may generate the position information of the terminal 100 before a predetermined time.

Moreover, the position information generator 106 may include a base station information processor (not shown) that generates the position information by using at least one adjacent base station information having a serving base station that the terminal 100 belongs. Here, the base station information processor may search an identifier with respect to at least one base station having the largest signal intensity among signals received, and/or may transmit an information request message including an identifier information about at least one base station, to a service system. Also, the base station information processor may generate the position information of the terminal 100 through a triangulation survey and statistical methods by using a base station identifier and a signal intensity information of the base station. It should be noted that the position information generation of the terminal 100 is not limited to the above methods and may use various kinds of methods.

The determination unit 108 determines whether to limit functions of the terminal 100 at a specified time (or a time period) stored in the storage unit 104. That is, position data in the setting data is compared with position information of the terminal 100 received from the position information generator 106 and then, if the position information of the terminal 100 is not included in or covered by the position data, it is determined to limit at least one function of the terminal 100. This means that the position data and position information are not identical or the position information of the terminal 100 is not included in a region provided in the position data.

If the position information is included in the position data, functions of the terminal 100 are not limited, meaning that the terminal is not lost. Thereafter, it generates a position information of the terminal 100 continuously or at a predetermined period in a corresponding time zone to determine whether to limit functions of the terminal 100. The terminal 100 then determines whether to limit functions of the terminal 100 using newly-generated position information of the terminal 100 when a time (or a time zone) of the next period or the next predetermined time (or time zone) comes.

The controller 110 controls to limit at least one function of the terminal 100 according to a determination result of the determination unit 108. That is, the controller 110 controls to limit at least one function of the message processor 112, the output unit 116, or the transceiver 114 when it has determined to limit functions of the terminal 100. A target for limiting functions of the terminal 100 is not limited to the units shown in FIG. 1 and may include other units in the terminal 100. That is, the controller 110 may execute at least one of (1) limiting function of a terminal except call and message receiving functions; (2) limiting an output about predetermined data (3) limiting a call with a predetermined number or a predetermined communication function; or (4) requesting functional limitations to a service system. According to one aspect, the controller 110 may control a target unit according to a predetermined execution function among the above (1) through (4) or a function to be limited. For example, in a case of (1), functions of the terminal 100 may be limited except a reception function of the transceiver 114 for executing a call and message receiving function and a message reception processing function of the message processor 112. For example, a function of the output unit 116 including sound or display output is limited or a transmission function of the transceiver 114 or a message transmission processing function of the message processor 112 may be limited. The controller 110 may continuously maintain the functional limitation before a control information for restoring functions of the terminal 100 is received or until a condition for functional restoration of the terminal 100 is satisfied.

Additionally, when the message processor 112 is controlled to limit functions of the terminal 100, it may transmit a message including a current position information of the terminal 100 which is generated to the telephone number of a third wireless mobile phone of basic contact information in the setting data. In this case, when the message processor 112 receives a message from an arbitrary terminal through the transceiver 114, it may transmit a message including generated position information of the terminal 100 to a third terminal in case of an emergency or to an arbitrary terminal preselected by a user.

The transceiver 114 may receive a functional restoration message from a service system. In response, the message processor 112 detects a value in a predetermined field of the functional restoration message as control information by parsing the received functional restoration message. The message processor 112 delivers a detection result to the controller 110 if the value of a predetermined field indicates a value for restoring functions of the terminal 100. Then, the controller 110 controls to restore at least one target unit having limited functions. That is, if a specific bit or a specific field of the functional restoration message is a predetermined value that the service system and the terminal 100 agree in advance, it may control to restore the functions of the terminal 100. Additionally, the functional restoration message may include at least one of pre-agreed caller number or pre-agreed message content. The received restoration message may not be stored in the terminal and deleted for security reasons.

If the controller 110 controls to limit various functions of the terminal 100, it may receive authentication information from a user through the input unit 102. The setting data stored in the storage unit 104 may further include an authentication information of the terminal 100. If the received input authentication information and the stored authentication information of the terminal 100 are identical through comparison, the controller 110 may control to restore functions of the terminal 100. Here, it may restore functions of the terminal 100 by selecting at least one of a method of using input authentication information and a method of using a functional restoration message. For example, if the input authentication is identical to the stored authentication information of the terminal 100 and a control information of the functional restoration message indicates a value for restoring functions of the terminal 100, the controller 110 may control to restore functions of the terminal 100. Accordingly, the limited function of the terminal 100 may be restored by the message processor 112 and the controller 110.

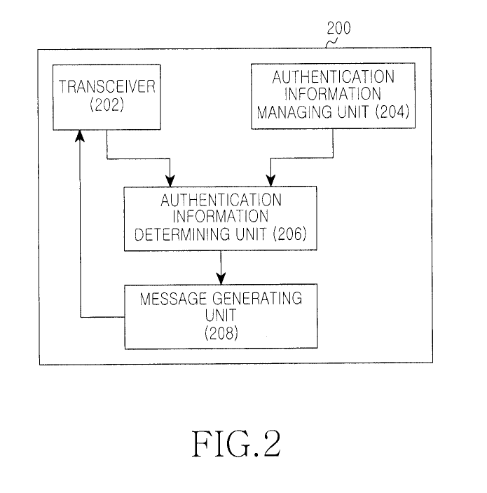

FIG. 2 is a block diagram illustrating a service system according to an embodiment of the present invention.

The service system 200 includes a transceiver 202, an authentication information managing unit 204, an authentication information determining unit 206, and a message managing unit 208.

The transceiver 202 receives an authentication information of a terminal to restore its limited functions from a user. The received authentication information may include a user information for the terminal, an authentication key set in the terminal in advance, or authentication data used in e-authentication.

The authentication information managing unit 204 stores a management authentication information for each user or terminal using a table means according to forms of authentication information. The table means may be updated by online access of a user or a service system manager.

The authentication information determining unit 206 determines whether authentication is successful or not according to a predetermined authentication process by comparing received authentication information with the management authentication information.

The message generating unit 208 generates a function restoration message according to a determination result of the authentication information determining unit 206. That is, if the terminal authentication is successful, the message generating unit 208 sets a predetermined bit or field of the terminal with a value representing a functional restoration of the terminal and transmits it to the corresponding terminal through the transceiver 202. Here, the value of the predetermined bit or field represents control information to restore the limited functional limitation of the terminal. For example, a Short Message Service (SMS) is used as a functional restoration message. A predetermined bit or field that a service system and a terminal establish may be set with a pre-agreed value and is included in an SMS message configured according to Common PCN (Personal Communication Network) Handset Specification (CPHS). The value of the predetermined bit or field in the functional restoration message may be used as control information to restore the terminal functions. Moreover, the functional restoration message may include at least one of pre-agreed caller number or pre-agreed message content. For example, when the functional restoration message includes “XXXXX119” of a caller number and “Unlock Terminal” of a body content, it may be used as control information to restore functions of the terminal.

Although not shown in FIG. 2, the service system 200 may further include a position information determining unit. Once the transceiver 202 receives a position information request message from a terminal, a position information determining unit determines a position information of the terminal using information of at least one base station in the request message. Here, the position information determining unit may determine the position information corresponding to an identifier about at least one base station using a table means which a base station identifier and position information are mapped into. Additionally, the request message may include a signal intensity information of a corresponding base station in addition to an identifier about at least one base station. Here, the position information determining unit may determine the position information of the terminal through a triangulation survey and statistical methods by using the base station identifier and the signal intensity information of the base station. The message generator 208 may transmit a message including the position information of the terminal determined by the position information determining unit to a corresponding terminal through the transceiver 202. Here, the determining of the position information of the terminal using base station information is not limited to the above methods and may include various kinds of other methods.

The transceiver 202 may receive a request for functional limitation from the terminal. Once the request for functional limitation of the terminal is received, the service system 200 may transmit a message that requests a communication functional limitation of a corresponding terminal, to a base station or an access control router. Here, a control message for requesting the communication functional limitation may include a phone number of a terminal, Subscriber Identification Module (SIM) authentication information, equipment authentication number, and equipment serial number as an identifier of the terminal. A base station or an access control router receiving the message for requesting communication functional limitation of a terminal may cut off a call connection of the terminal or may not allow the terminal to enter a network.

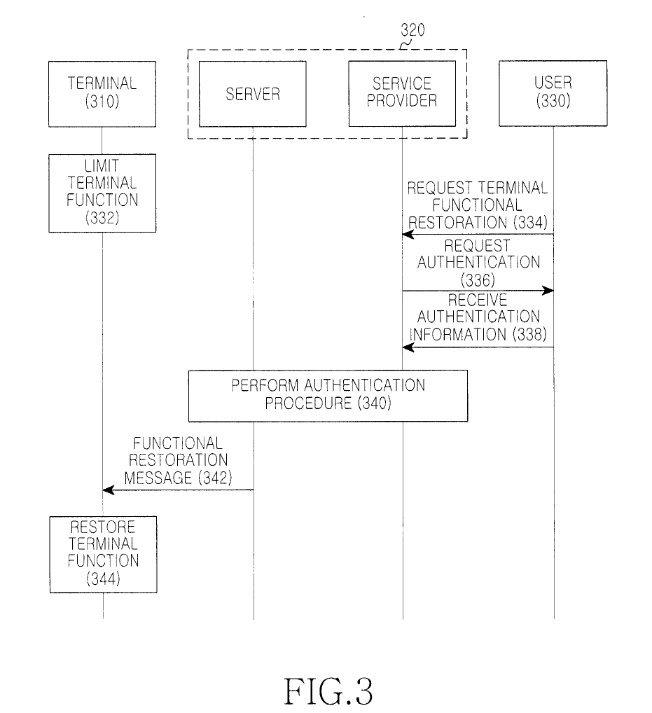

FIG. 3 is a flowchart illustrating the operations of a terminal and a service system according to an embodiment of the present invention.

The service system 320 includes a server and a service provider (or a service system). Also, the server and the service provider may be integrated as one system. Message exchanges between a terminal 310 and the service system 320 require a base station and an access control router but for convenience of description, the base station and the access control router providing service to the terminal 310 will be omitted. Since the base station and the access control router may participate in an authentication procedure in step 340, the service system 320 may include a base station and an access control router.

If a position information of the terminal 310 is not included in the position data provided in the setting data at a time specified in the setting data, the functions of the terminal 310 are limited in order to protect information of the terminal 310 in step 332.

The service system 320 receives a functional restoration request about the terminal 310 from a user 330 in step 334. The service system 320 requests authentication information necessary for authentication of the terminal 310 to the user in step 336 and in turn receives the authentication information necessary for authentication of the terminal 310 from the user in step 338. Additionally, as substitutions of steps 334 through 338, the service system 320 may directly receive a functional restoration request of the terminal 310 including authentication information from the user 330.

The service system 320 performs a predetermined authentication procedure using the received authentication information in step 340, then it is determined whether the authentication of the terminal 310 is successful or not. If successful, the service system 320 transmits a functional restoration message 342 to the terminal 310. At this point, the functional restoration message 342 may be transmitted through an access control router and a base station. If the authentication of the terminal is unsuccessful, the service system 320 may request the authentication information to the user again or the operations of FIG. 3 may be terminated.

The terminal 310 receives a functional restoration message 342 from a service system 320. If a specific bit or a specific field of the functional restoration message 342 represents a value that the service system 320 and the terminal 310 pre-defined, a limited function of the terminal 340 is restored in step 344.

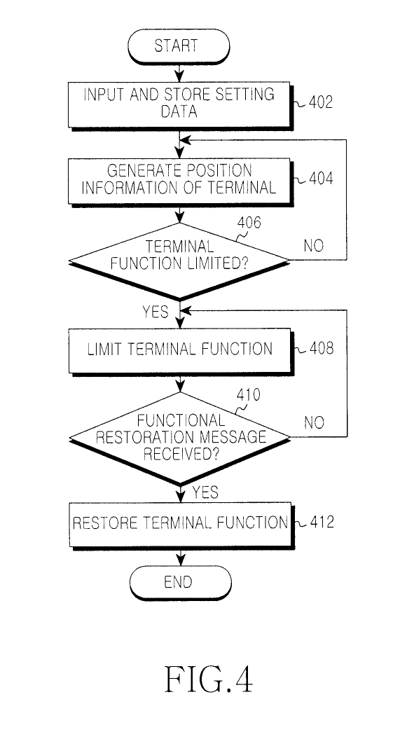

FIG. 4 is a flowchart illustrating an information protection procedure of a terminal according to an embodiment of the present invention.

A terminal receives setting data including time data and position data and then stores them in a storage unit in step 402. The setting data may be inputted by a user through the terminal or the setting data that a user sets may be transmitted from a service system. The terminal generates its position information representing a current position of the terminal in step 404. Thereafter, the terminal compares the position data with the generated position information at a time specified by the time data stored in the storage unit, and then determines whether to limit some or all functions of the terminal or not in step 406. At this point, when the position data is not identical to the generated position information, it is determined that the terminal function has to be intervened according to predetermined criteria. Otherwise, in step 406, it proceeds to step 404 and then generates the position information of the terminal.

If it is determined to limit functions of the terminal in step 406, the terminal limits at least one function in step 408.

Thereafter, the terminal determines whether a functional restoration message including a control information to restore the functions of the terminal is received or not in step 410. If the functional restoration message is not received, the terminal maintains its functional limitation of step 408. If the functional restoration message is received, the terminal restores it functions in step 412.

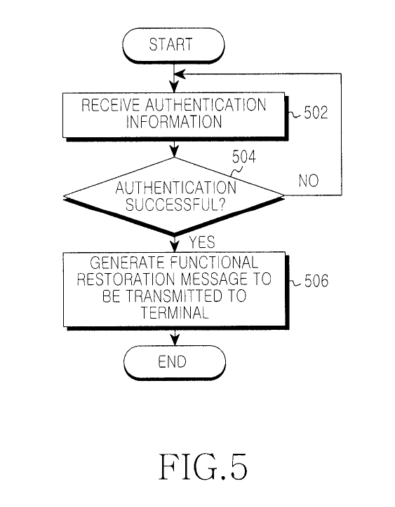

FIG. 5 is a flowchart illustrating operations of a service system for protecting information of a terminal according to an embodiment of the present invention.

A service system receives authentication information from a user in step 502. The service system performs a predetermined authentication procedure using the received authentication information and determines whether authentication about the terminal is successful or not in step 504. If the authentication is unsuccessful in step 504, the service system requests the authentication information to the user again in step 502. If the authentication is successful in step 504, the service system generates a functional restoration message to be transmitted to the terminal in step 506. The functional restoration message includes a value of a predetermined bit or field and a corresponding value may be used as control information to restore the functions of the terminal. The generated functional restoration message is transmitted to the terminal. The generated functional restoration message is transmitted to the terminal.

It should be noted that the embodiments of the present invention may be realized in a program command form to be executed through various computer means and may be written on a computer readable recoding medium. The computer readable recoding medium may include one or combinations of a program command, a data file, and a data structure. The program commands written on the medium may be those designed especially for the present invention or known to computer software engineers skilled in the art.

In addition, the above-described methods according to the present invention can be realized in hardware or as software or computer code that can be stored in a non-transitory recording medium such as a CD ROM, a RAM, thumbnail drive, a floppy disk, a flash storage, a hard disk, or a magneto-optical disk or downloaded over a network and stored in storage, so that the methods described herein can be executed by such software using a general purpose computer, special computer, microprocessor, special processor, or in a programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

The above mentioned present invention generates a position information of a terminal and compares the position information with previously stored setting data to determine whether to limit some or all functions of the terminal in order to provide security for a terminal unit and a service system.

Moreover, when functions of a terminal are limited, by transmitting a message including position information of the terminal to a third party of basic contact information, a method of protecting information of a terminal unit, a service system, and the terminal is provided to a user for convenient management of the terminal.

Furthermore, when the functions of a terminal are limited, by automatically transmitting a message including the current position information of the terminal when a message is received from an arbitrary terminal during the limitation of the functions of a terminal, a method of protecting information of a terminal unit, a service system, and the terminal is provided to a user for convenient management of the terminal.

Additionally, when the functions of a terminal are limited, by restoring the functions limited through a functional restoration message from a service system, a method of protecting information of a terminal unit, a service system, and the terminal is provided to a user for a reliable information protecting technique.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A terminal for protecting information, comprising:
an input unit receiving setting data including time data and position data;
a storage unit storing the received setting data;
a position information generating, unit generating a position information of the terminal;
a determination unit comparing the position data with the generated position information to determine whether to limit functions of the terminal at a time specified in the time data; and
a controller controlling to limit at least one function of the terminal according to the determination outcome.

2. The terminal of claim 1, wherein when the determination unit determines to limit the functions of the terminal, the controller performs at least one of:
limiting all functions of the terminal except a call and message receiving function;
limiting an output for a predetermined data;
limiting a call connection relating to a predetermined number or a predetermined communication function; and
requesting a functional limitation of the terminal to a service system.

3. The terminal of claim 1, further comprising a message processor transmitting a message including the generated position information to another terminal specified in the setting data.

4. The terminal of claim 1, wherein upon receiving a functional restoration message from a service system, the controller controls to restore the at least one function of the terminal.

5. The terminal of claim 4, further comprising a message processor detecting a value in a predetermined field of the functional restoration message by parsing the functional restoration message.

6. The terminal of claim 1, wherein the setting data further comprises an authentication information corresponding to the terminal; and
the controller restores the at least one function of the terminal when an authentication data inputted by a user matches the authentication information in the setting data.

7. The terminal of claim 1, wherein the position information generating unit comprises a Global Positioning System (GPS) receiving unit generating the position information.

8. The terminal apparatus of claim 1, wherein the position information generating unit comprises a base station information processor generating the position information by using at least one adjacent base station information.

9. A service system for protecting information, comprising:
an authentication information managing unit storing and managing an authentication information for restoring a function of a terminal;
a message generating unit generating a message including a control information that represents the function restoration of the terminal;
a transceiver receiving an input authentication information and transmitting the message to the terminal; and
an authentication information determining unit determining whether authentication is successful or not by comparing the stored authentication information with the received input authentication information,
wherein the message generating unit generates the message according to the determination outcome.

10. The service system of claim 9, wherein the control information is a value that a predetermined field of the message represents the restored function of the terminal.

11. A method for protecting information of a terminal, the method comprising:
maintaining a storage unit storing setting data including time data and position data;
generating a position information of a terminal;
determining whether to limit functions of the terminal by comparing the position data with the generated position information at a time specified in the time data stored in the storage unit; and
controlling to limit at least one function of the terminal according to the determination outcome.

12. The method of claim 11, wherein limiting the at least one function of the terminal comprises at least one of:
limiting all functions of the terminal except a call and message receiving function;
limiting an output for predetermined data;
limiting a call connection relating to a predetermined number or a predetermined communication function; and
requesting a functional limitation of the terminal to a service system.

13. The method of claim 11, further comprising transmitting a message including the generated position information to another terminal specified in the setting data.

14. The method of claim 11, wherein the comparison step comprises determining whether a current location of the terminal falls within a predetermined distance range from a location specified by the position data.

15. The method of claim 11, further comprising, wherein upon receiving a functional restoration message from a service system, controlling to restore the at least one function of the terminal in response to the functional restoration request.

16. The method of claim 15, wherein restoring the at least one function of the terminal comprises detecting a value in a predetermined field of the functional restoration message by parsing the functional restoration message.

17. A terminal for restoring a limited function, comprising:
a storage unit storing setting data including time data and position data;
a position information generating unit generating a position information of the terminal;
a controller controlling to limit at least one function of the terminal when the generated position information is not included in the position data at a time specified by the time data; and
a transceiver receiving a functional restoration message including a control information from a service system.
wherein the controller controls to restore the at least one function of the terminal according to the control information.

18. The terminal of claim 17, wherein the setting data further comprises a basic contact information, and the terminal further comprising a message processor transmitting a message including the generated position information to another terminal specified in the setting data.

19. The terminal of claim 11, wherein the controller limit the at least one function when a current location of the terminal does not fall within a predetermined distance range from a location specified by the position data.

20. A method for restoring a limited function in a terminal, the method comprising:
maintaining a storage unit storing setting data including time data and position data;
generating a position information of a terminal;
controlling to limit at least one function of the terminal when the generated position information is not included in the position data at a time specified in the time data;
receiving a functional restoration message including control information from a service system; and
controlling to restore the at least one function of the terminal according to the control information.
